(19) United States
(12) Patent Application Publication
(10) Pub. No.: US 2016/0356495 A1
(43) Pub. Date: Dec. 8, 2016

(54) METHOD AND SYSTEM FOR OPERATING A COMBUSTION DEVICE

(71) Applicant: ANSALDO ENERGIA IP UK LIMITED, London (GB)

(72) Inventors: Stefano BERNERO, Oberrohrdorf (CH); Xiao-Yi ZHANG, Niederrohrdorf (CH); Klaus KNAPP, Gebenstorf (CH); Ken Yves HAFFNER, Baden (CH)

(73) Assignee: ANSALDO ENERGIA IP UK LIMITED, London (GB)

(21) Appl. No.: 15/170,258

(22) Filed: Jun. 1, 2016

(30) Foreign Application Priority Data
Jun. 2, 2015 (EP) 15170225.5

(51) Int. Cl. F23N 5/00; F02C 9/26; F23R 3/28

(52) U.S. Cl. CPC F23N 5/003; F23R 3/28; F02C 9/26; F05D 2220/32; F05D 2270/082; F05D 2270/16; F05D 2270/804

(57) ABSTRACT

The present disclosure generally relates to the field of combustion technology related to gas turbines. For example, the present disclosure refers to a system and a method for operating a combustion device. Advantageously, required measurements may be effected fast enough to ensure an optimum control of parameter w, defined as a ratio between NOx water mass and fuel oil flows, the measurements being based not only on process variables but, most importantly, on NOx levels.

### TECHNICAL FIELD

The present invention generally relates to the field of combustion technology related to gas turbines. More in particular, the present invention refers to a method and system for operating a combustion device.

### BACKGROUND

As well known, emission regulations require low pollutant emission levels, which in the current state-of-the-art can be usually reached in gaseous fuel operation without any water addition thanks to premix combustion technologies. In liquid fuel operation, however, for most of the gas turbines addition of NOx water is mandatory to prevent pulsations, high NOx emissions and burner/combustor overheating. The ratio between the quantity of water introduced and the fuel is generally referred to as parameter ω (NOx water to fuel oil mass flow ratio). An example of how different combustor characteristics may react to varying proportion of NOx water or ω for a given operation point is shown in FIG. 1, where also possible operational limitations due to emission regulation or lifetime impact due to combustor pulsation levels are indicated. FIG. 2 shows the diagram of FIG. 1 where an optimum value ω* is indicated which should be kept during the combustion process to avoid high pulsations, to remain below NOx limit regulations and, at the same time, contain within acceptable ranges the water consumption.

Gas turbine combustor operation needs to be optimized for pulsation and emissions over a wide operating range. Typically, NOx water mass flow is scheduled as a function of gas turbine process variables, such as, for example, VIGV position and turbine exhaust temperature. These functions are pre-defined during engine adjustment based on combustor mapping results at a few points and boundary conditions under steady state. Typically, the combustor behaviour is heavily affected by ambient conditions, fuel property and hardware conditions, etc. The pre-defined NOx water to fuel oil mass flow ratio (ω) is optimal for a specific engine and under operation and boundary conditions at the time of adjustment, but the optimum might differ during continuous commercial operation.

Disadvantages of current solutions are that high margins to pulsation and NOx limits need to be included in the parameters settings in order to cover the expected variations in operation, which results in higher NOx water consumption and therefore important operational costs. Also, if larger deviations than expected occur in the boundary conditions or combustion characteristics, undesired events might be experienced leading to emission non-compliance or protection actions due to pulsation and therefore causing reduced engine reliability. Additionally, on site adjustment of the ω schedule is time consuming and leads to an increased commissioning and outage duration. Automatic ω adjustment is proposed in U.S. Pat. No. 6,679,060B2, EP1215382B1 based on measurement of at least one among pulsation, material temperature, and flame position. These can be used to optimize pulsation and overheating risks but may still lead to high NOx levels and NOx water consumption.

### SUMMARY OF THE INVENTION

It is an object of the present invention to solve the aforementioned technical problem by providing a system for operating a combustion device as substantially defined according to independent claim 1.

It is a further object of the present invention to provide method for operating a combustion device as substantially defined in independent claim 9.

According to an aspect of the invention, this object is obtained by a system for controlling a combustion process of a gas turbine, the gas turbine comprising a combustor and a fuel feeding system configured to control parameter ω defined as a ratio between NOx water and fuel oil mass flows, wherein the system comprises an apparatus for measuring NOx emission levels in the exhaust of the combustor; a measurement arrangement for measuring combustion process variables; a controller configured to receive input signals corresponding to measured NOx and process variables respectively from the apparatus and the measurement arrangement, to elaborate a value for the parameter ω based on the input signals and to generate and send an output signal correspondent to the calculated value directed to the fuel feeding system.

According to a preferred aspect of the invention, the apparatus for measuring NOx emission levels is capable to carry out such operation within a time frame which is shorter than 20 sec.

More preferably, the apparatus for measuring NOx emission levels is capable to carry out such operation within a time frame which is shorter than 10 sec.

More preferably, the apparatus for measuring NOx emission levels is capable to carry out such operation within a time frame which is shorter than 2 sec.

Even more preferably, the apparatus for measuring NOx emission levels is capable to carry out such operation within a time frame which is shorter than 1 sec.

According to a preferred aspect of the invention, the measuring arrangement may comprise a device configured to measure pulsation levels within the combustor.

According to a preferred aspect of the invention, the apparatus for measuring NOx emission levels may comprise an optical sensor device providing an array of nano and/or microcrystalline fibers.

According to a preferred aspect of the invention, the system may comprise a fluid sample extraction assembly located in a combustor plenum, wherein the apparatus for measuring NOx emission levels is located at ambient conditions and is fluidically connected to the fluid sample extraction assembly.

According to a preferred aspect of the invention, the apparatus for measuring NOx emission levels comprises a sensor located inside a combustor plenum and an evaluation unit connected thereto in turn located at ambient conditions.

According to a preferred aspect of the invention, the controller may comprise first means for calculating a Δω based on measured levels of NOx emissions and pulsation levels.

According to a preferred aspect of the invention, the controller may comprise second means for calculating a parameter ω′ as a predefined function of measured process variables.

According to a preferred aspect of the invention, the controller may comprise a subtracting device configured to receive input signals corresponding to the value of ω′ calculated by the second means and to the value of Δω calculated by the first means, and to generate and send to the fuel feeding system an output signal corresponding to a value: ω=ω′−Δω.

According to a further object of the invention, it is provided a method for controlling a combustion process of a gas turbine, the gas turbine comprising at least a combustor and a fuel feeding system configured to control parameter ω defined as a ratio between NOx water mass and fuel oil flows, said method including the steps of: measuring NOx emission levels in the exhaust of the combustor; measuring combustion process variables; elaborating a value for parameter ω based on the NOx emissions and measured process variables and generating an output signal correspondent to the value ω directed to the fuel feeding system.

According to a preferred aspect of the invention, measuring NOx emission levels is carried out within a time frame which is shorter than 20 sec.

More preferably, the NOx measures are carried out within a time frame which is shorter than 10 sec.

More preferably, the NOx measures are carried out within a time frame which is shorter than 2 sec.

Even more preferably, the NOx measures are carried out within a time frame which is shorter than 1 sec.

According to a preferred aspect of the invention, the measuring combustion process variables may include measuring pulsation levels within the combustor.

According to a preferred aspect of the invention, the step of elaborating a value for said parameter ω may comprise calculating a parameter ω′ as a predefined function of measured process variables.

According to a preferred aspect of the invention, the step of elaborating a value for said parameter ω may comprise a step of calculating a Δω based on measured levels of NOx emissions and pulsations.

According to a preferred aspect of the invention, the step of elaborating a value for said parameter ω may comprise a step of subtracting the Δω from ω′ and generating and sending to the fuel feeding system an output signal corresponding to a value ω=ω′−Δω.

### BRIEF DESCRIPTION OF THE DRAWINGS

The objects, advantages and other features of the present invention will become more apparent upon reading of the following non-restrictive description of preferred embodiments thereof, given for the purpose of exemplification only, with reference to the accompany drawing, through which similar reference numerals may be used to refer to similar elements, and in which:

FIGS. 1 and 2 show an operational diagram indicating various correlations between the ω of the process and other process variables;

FIG. 3 shows a simplified diagram of a system for controlling a combustion process according to the present invention;

FIG. 4 show a first example of a disposition of an apparatus for measuring NOx emission levels;

FIGS. 5 and 6 show a second example of disposition of an apparatus for measuring NOx emission levels;

FIG. 7 shows a third example of disposition of an apparatus for measuring NOx emission levels;

FIGS. 8 and 9 show a fourth example of disposition of an apparatus for measuring NOx emission levels;

FIG. 10 illustrates a block diagram of a first embodiment of a control logic according to a method of the present invention;

FIG. 11 shows in more detail a portion of the diagram of FIG. 10;

FIG. 12 illustrates a block diagram of a second embodiment of a control logic according to a method of the present invention;

FIGS. 13 and 14 show diagrams illustrating the variance of parameter ω according to predefined correlations

FIGS. 15 and 16 show respectively different groupings for different kind of combustors and examples of staging options.

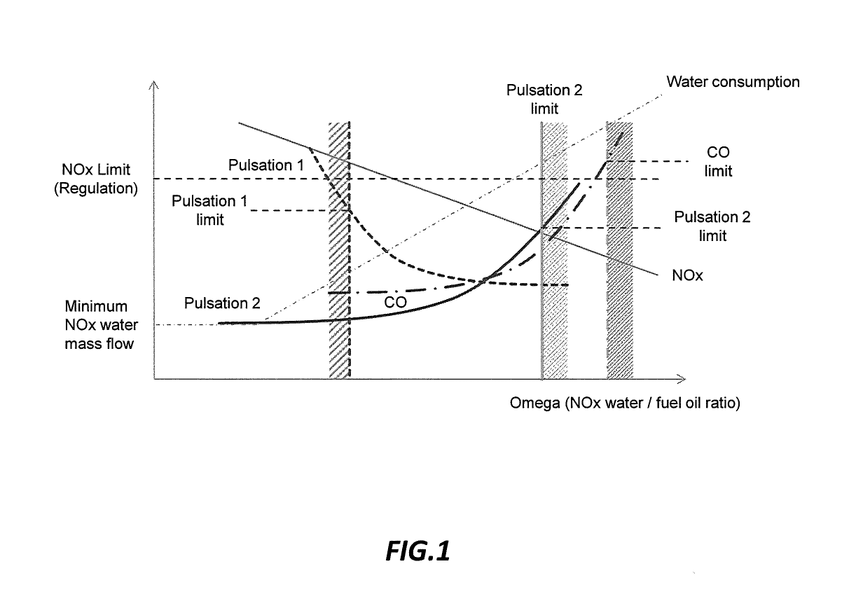

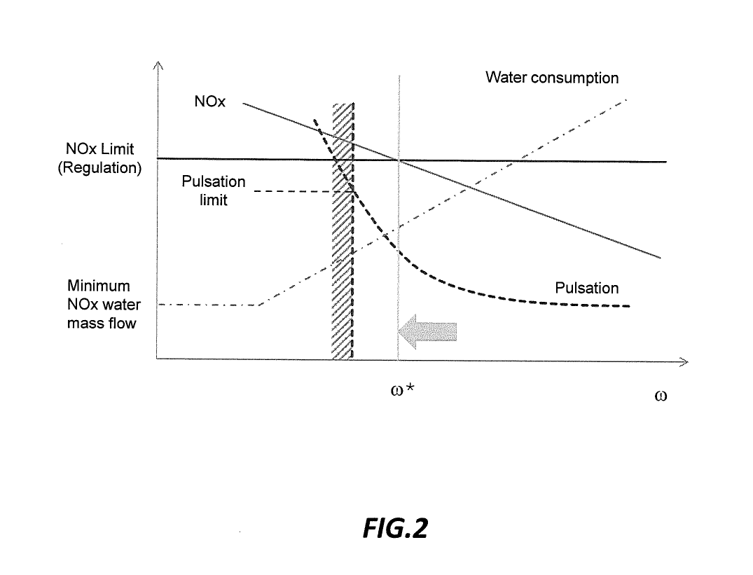

Exemplary preferred embodiments of the invention will be now described with reference to the aforementioned drawings.

### DETAILED DESCRIPTION OF THE INVENTION

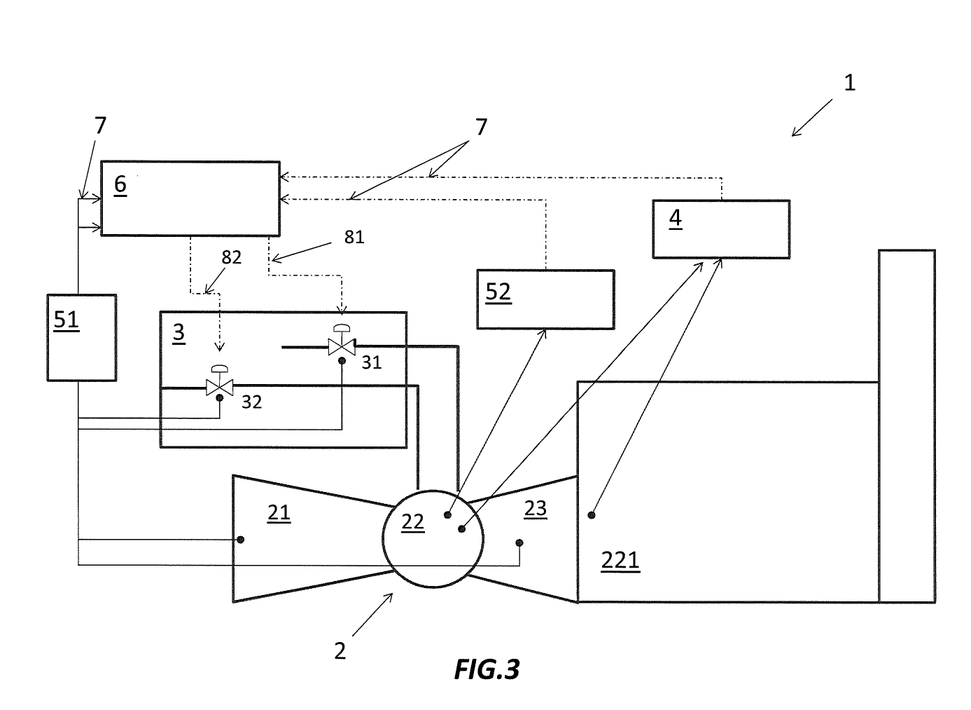

With reference to FIG. 3, it is shown a simplified diagram of a system 1 for controlling a combustion process according to the present invention. More in particular, system 1 is associated to a gas turbine 2, which in turn comprises a compressor section 21, a combustor 22 and a turbine section 23. System 1 is also associated to a fuel feeding system, generally referred to with numeral reference 3 in the scheme of FIG. 3. The fuel feeding system 3 comprises a first means 31 to feed fuel into the combustor 22 and a second means 32 to control parameter ω, therefore enabling the addition of water to the fuel.

The system 1 comprises an apparatus 4 adapted to measure NOx emission levels produced in the combustor 22 and/or in an exhaust 221 of the combustor 22, and a measurement arrangement 51, 52 for measuring other process variables. More in particular, arrangement 51 is adapted to measure process variables such as, for example, TAT (Temperature after Turbine), VIGV (Variable inlet guide vane angle), LHV (Low heating Value) and β (Fuel Gas mass flow to total fuel mass flow ratio), the latter being define by the following equation:

$${Beta}_{TOTAL} [ \% ] = \frac{{\dot{m}}_{GAS} \cdot {LHV}_{GAS}}{{\dot{m}}_{GAS} \cdot {LHV}_{GAS} + {\dot{m}}_{OIL} \cdot {LHV}_{OIL}} * 100$$

Arrangement 51 is configured to measure the current value of parameter ω, by calculating the flows of fuel and water.

Arrangement 52 is configured to measure pulsation levels within the combustor.

The system 1 according to the invention comprises a controller 6, such as a data processor, configured to receive input signals 7 corresponding to the measured NOx levels and to other process variables, respectively from apparatus 4 and from measuring arrangements 51, 52 to elaborate a value for the parameter ω based on those input signals and to send correspondent output signals 81 (fuel oil mass flow command) and 82 (NOx water mass flow command) to the fuel feeding system 3, which in turn regulates parameter ω of the process, in other words the ratio of water of the fuel-water emulsion introduced in the combustor.

A fuel feeding system is a configuration well-known in the art and therefore a detailed description of the same will be herewith omitted.

Advantageously, apparatus 4 for measuring the NOx levels is capable of measuring NOx emissions within a timeframe shorter than twenty seconds.

According to preferred embodiments, such NOx level measurements may be carried out within a time frame shorter than ten seconds. According to preferred embodiments, such NOx level measurements may be carried out within a time frame shorter than two seconds.

According to preferred embodiments, such NOx level measurements may be carried out within a time frame shorter than one second.

In this way, required measurements may be effected fast enough to ensure an optimum control of ω based not only on process variables but, most importantly, on NOx levels.

In particular, a typical time interval (cycle time) for a gas turbine closed loop control is fifty msec. Hence, parameter ω is elaborated every fifty msec.

Apparatus 4 for measuring NOx levels may utilize technologies based on molecular-level measurements using stimulated Raman scattering.

As a preferred and non-limiting example, apparatus 4 may include an optical sensor device for local analysis of a combustion process of a thermal power plant, which includes at least one wavelength selective optical element exposed directly or indirectly to hot combustion gases. More in particular, the optical element an array of nano and/or microcrystalline fibres which are created by shear flow crystallization.

Such device is known in the art and described in US 2007/0133921. By means of such optical device, local gas diagnostics, particularly for NOx pollutant emission levels, can be achieved within time frame shorter than 20 seconds.

According to preferred embodiments, optical device described in US 2007/0133921 may be adapted to achieve such NOx emission levels within a time frame shorter than ten seconds.

According to preferred embodiments, optical device described in US 2007/0133921 may be adapted to achieve such NOx emission levels within a time frame shorter than two seconds.

According to preferred embodiments, optical device described in US 2007/0133921 may be adapted to achieve such NOx emission levels within a time frame shorter than one second.

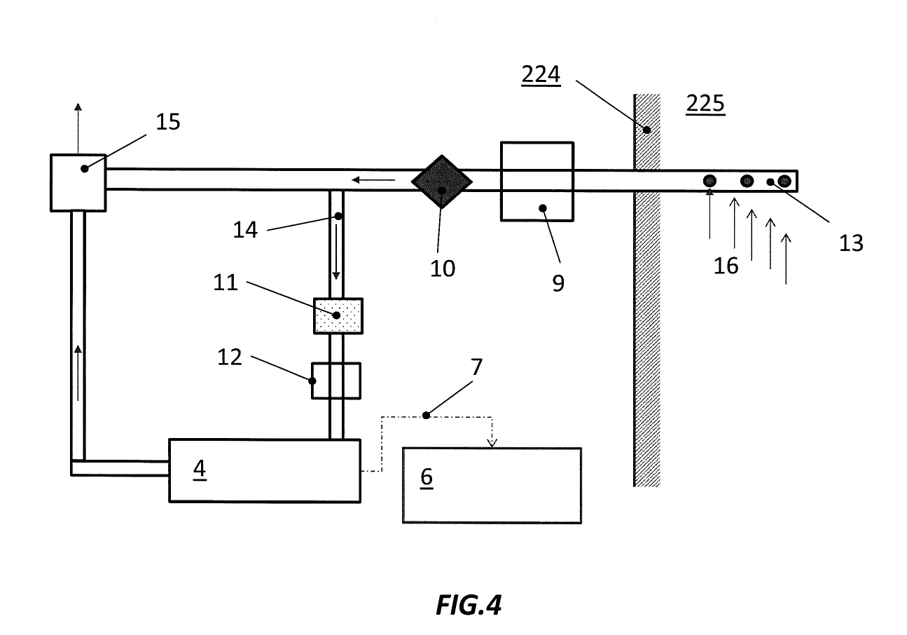

With reference to next FIG. 4, it is shown a possible configuration of the system for controlling a combustion process according to the invention. In particular, apparatus 4 for measuring NOx emissions is located at ambient conditions (ca 20 C and 101.3 kPa) and exhaust gases 16 in a combustor plenum 225 (ca 700 K and 2 Mpa), surrounded by a gas turbine casing 224, are extracted by means of a fluid sample extraction assembly 13 located inside the combustor plenum 225 and fluidically connected to the apparatus 4. The exhaust gases 16 are led through a cooler 9 and a pressure reduction valve 10. Then the gas to be analysed is directed to the apparatus 4 through a bypass duct 14 which comprises one or more filters 11 and, preferably, a drier 12. The apparatus 4 performs the measurements, calculates the value of NOx levels and sends the correspondent output signal 7 to the controller 6. The exhaust gas going through the apparatus 4 is then expelled by means of a vent 15. Advantageously, the bypass flow of exhaust gases through the bypass duct 14 allows a reduction of the measurement time.

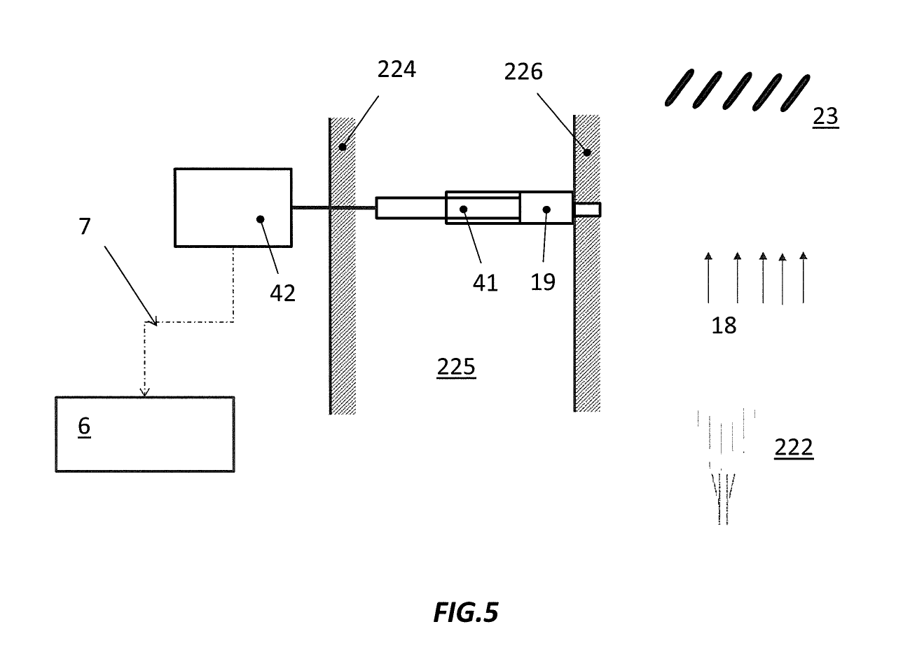

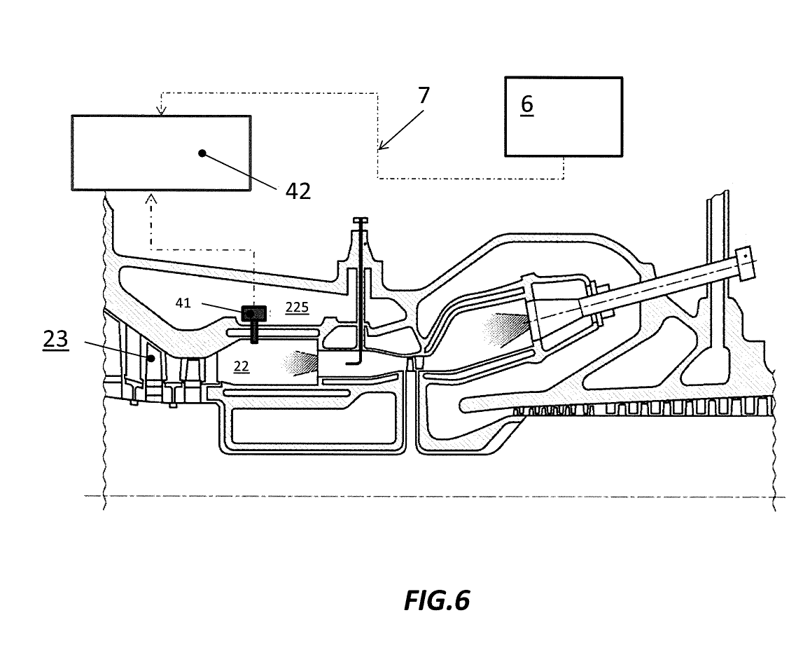

Making now reference to following FIGS. 5 and 6, it is depicted another example of a possible configuration for the system for controlling a combustion process according to the invention. In this case, the apparatus for measuring NOx levels comprises a sensor 41 located inside the combustor plenum 225 delimited by the gas turbine casing 224 and a combustion liner 226. The sensor 41 senses hot gases 18 coming from the combustor chamber 222, where the temperature is around 1700 K and the pressure equal to 2 Mpa, through an upstream filter 19. The apparatus for measuring NOx levels further comprises an electronic evaluation unit 42 which sends the output signal 7, corresponding to the NOx current value, to the controller 6.

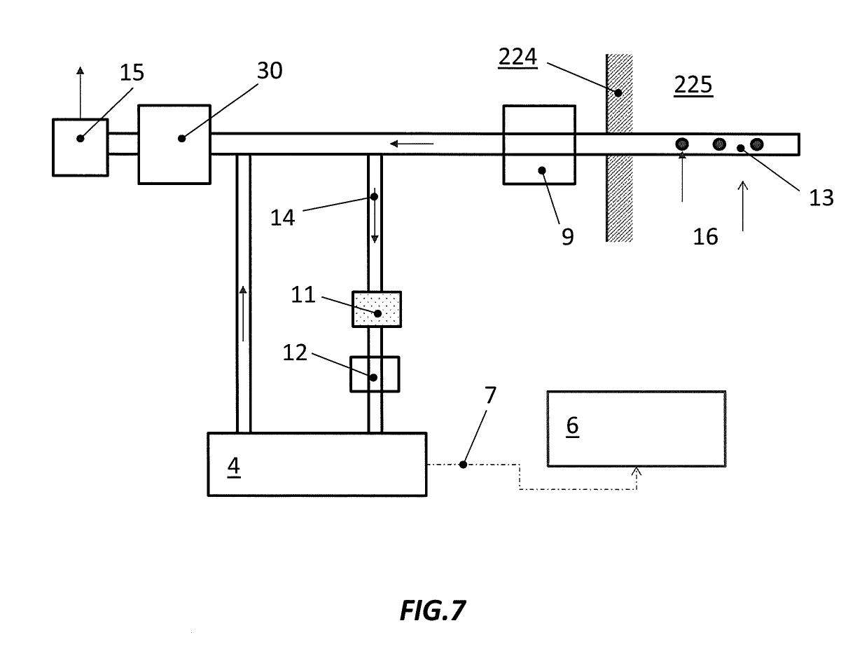

With reference to FIG. 7, it is shown yet another example of apparatus 4 located at ambient conditions. The configuration shown is similar to the one depicted in FIG. 5 with the sole difference that the pressure reduction valve is absent and it is replaced by an extraction pump 30, positioned downstream the apparatus 4, configured to withdraw hot gas samples 16 located in the combustor plenum 225 through the sample extraction assembly 13.

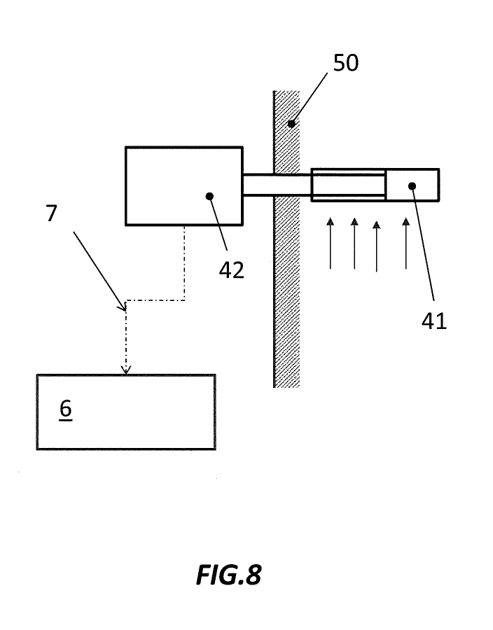

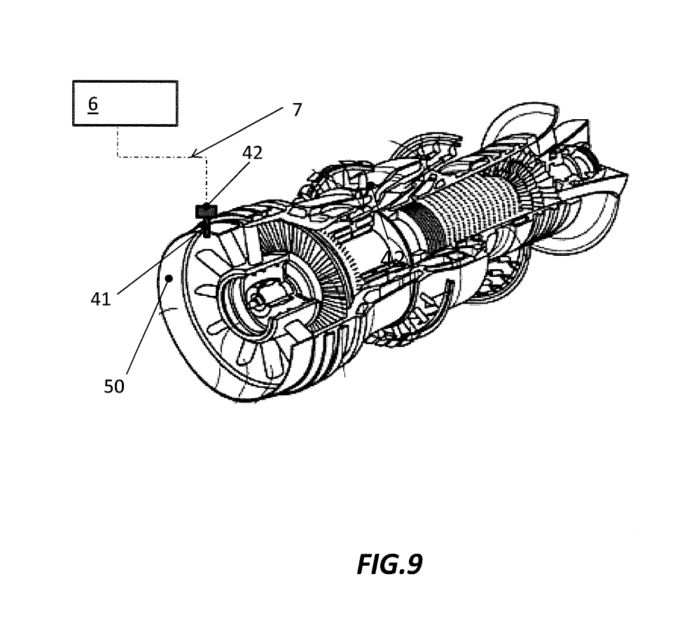

Alternatively, as shown in FIGS. 8 and 9, the sensor 41 may be located within a gas turbine gas casing 50, where the temperature is around 600 C and the pressure equal to 101.3 kPa, and then connected to the electronic evaluation unit 42 which is located at ambient conditions as described for the example illustrated in FIG. 6.

The system for controlling the combustion process as described operating according to a method as described below.

The method according to the invention includes the step of measuring NOx emission levels in the exhaust of the combustor; measuring combustion process variables; elaborating a value for parameter ω based on the measured NOx emission levels and process variables; generating an output signal corresponding to the calculated ω and sending it to the fuel feeding system.

According to preferred embodiments the NOx measurement is accomplished within a time frame shorter than twenty seconds.

According to preferred embodiments, the NOx measurement is accomplished within a time frame shorter than ten seconds.

According to preferred embodiments, the NOx measurement is accomplished within a time frame shorter than two seconds.

According to even more preferred embodiments, the NOx measurement is accomplished within a time frame shorter than one second.

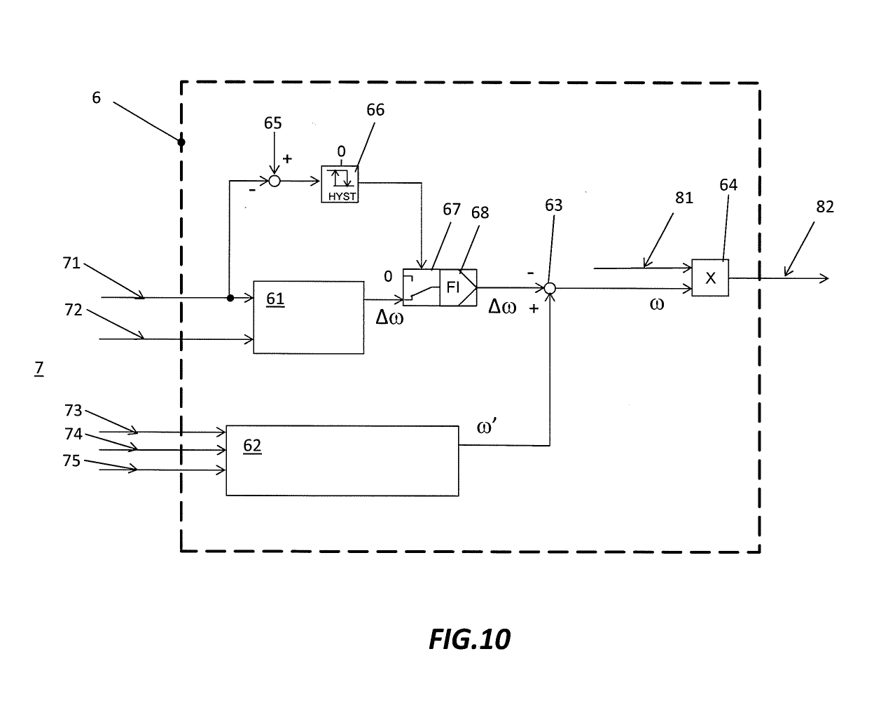

Making now reference to FIG. 10, it is shown a block diagram illustrating the method according to the invention. In particular, measured quantities, overall indicated with numeral 7, include signals corresponding to the measured NOx levels 72, the pulsation levels 71 and other process variables, like TAT 73, VIGV 74 and β 75 to quote some non-limiting examples.

Signals 7 reach the controller unit 6 where they are elaborated in order to generate a value for parameter ω to be sent to the fuel feeding system. In particular, controller 6 comprises first means 61, which receives input signals 72 and 71 respectively corresponding to measured levels of NOx and pulsations, for calculating a Δω which represents a possible reduction of the value of ω, as it will be better explained in the following.

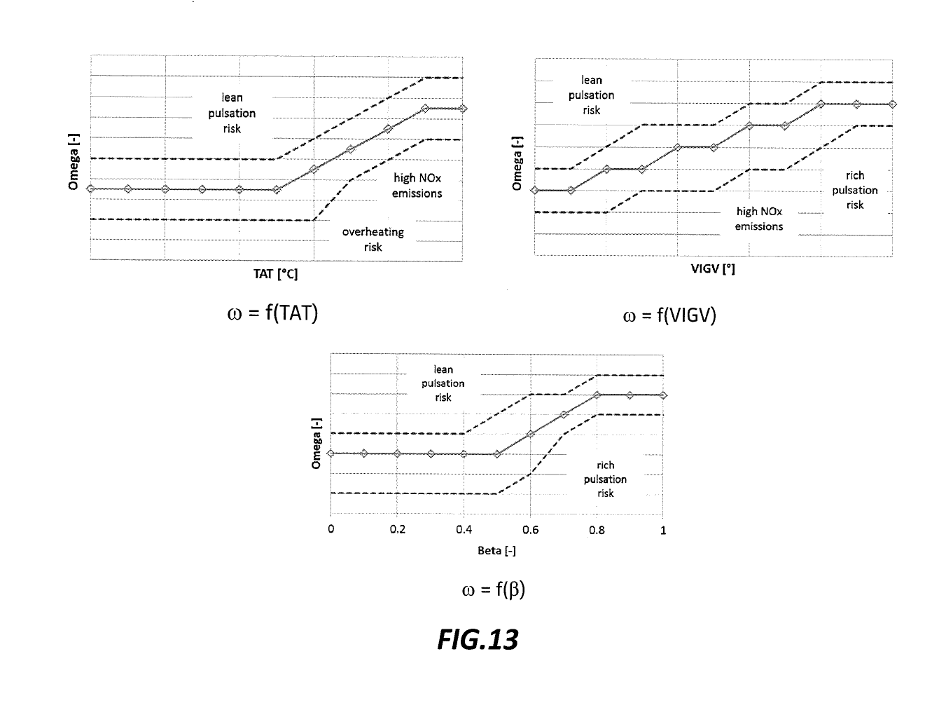

Controller 6 further comprises second means 62, which receives as input signals process variables measurements 73, 74 and 75. Second means 62 elaborate of value ω′ based on predefined functions of said measured process variables. In FIG. 13 graphs showing these typical functions are illustrated. They are defined based on combustor mapping results in order to keep enough margins from high pulsation and high NOx emission areas. Second means 62 utilize these functions, in a way known to those who are skilled in the art, to calculate ω′.

However, the combustor behaviour is heavily affected by ambient conditions, fuel property and hardware conditions. The pre-defined ω functions are optimal for an average engine and under average operative conditions, but usually result in too high NOx water consumption, with significant cost increase.

First means 61 and second means 62 send, respectively, the reduction value Δω and the value ω′ to a subtracting device 63 which generates and sends to the fuel feeding system an output signal corresponding to a value

ω=ω′−Δω

Generated ω value and signal 81 corresponding to the fuel oil mass flow command are sent to a multiplier 64 which generates the NOx water mass flow command 82 which is sent to the fuel feeding system.

According to preferred embodiments, signal 71 corresponding to measured pulsation levels is sent, upstream the first means 61, to a subtracting device 65. The subtracting device 65 subtracts the measured pulsation value from a predefined pulsation limit value and the result is fed to a threshold block 66 with hysteresis. The threshold block 66 is in turn connected to a switch 67. It switches between two inputs: 0 or Δω coming from first means 61, as detailed above. If the measured pulsation is below the pulsation limit, then Δω will be selected and passed to a gradient limiter 68 and subsequently to subtracting device 63. Otherwise, if pulsation limit has been reached or passed, 0 will be selected and no reduction Δω will be enabled.

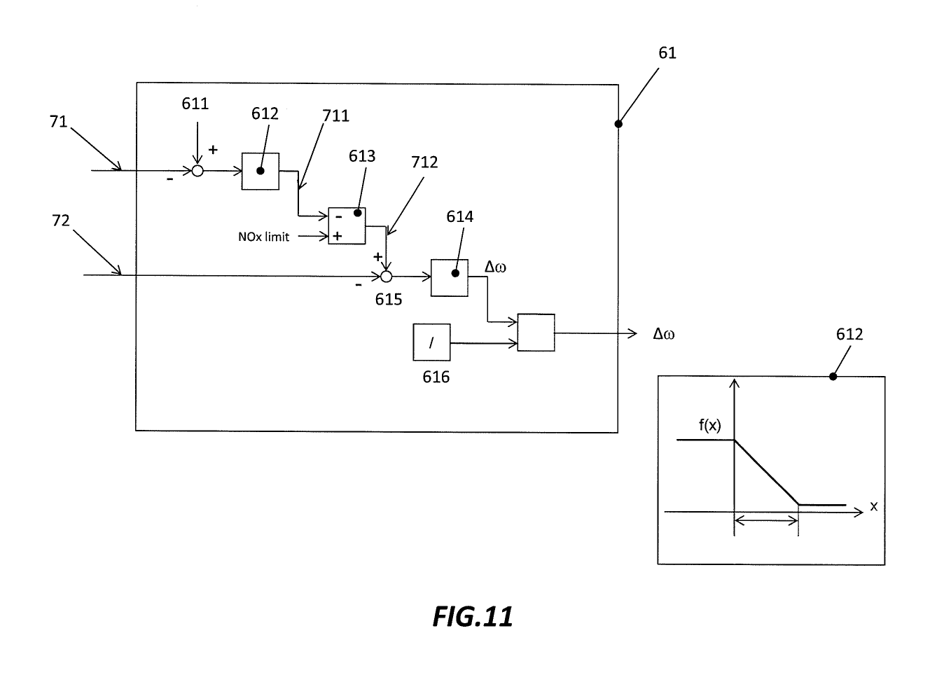

First means 61 is better detailed with reference to next FIG. 11, which will be now discussed. In particular, measured pulsation 71 is fed to a subtracting device 611 which calculates the difference between the predefined pulsation limit and the measured pulsation 71. Device 611 then feeds the result to a function block 612, which is shown in a better detail in the bottom-right corner of the figure. Function block 612 has the purpose of calculating a necessary reduction from a predefined NOx emission level limit in order to keep the combustion away from high pulsation area. In the graph of block 612, x represents the input fed by the subtracting device 611, that is the difference between the pulsation limit and the measured pulsation 71. The output f(x), identified in the scheme with numeral 711, indicates the necessary reduction of NOx from the NOx limit calculated as a function of x.

Subsequently, block 613 calculates a NOx target value 712 by subtracting the calculated reduction of NOx 711 from the NOx limit value. First means 61 further comprises a PI controller 614 which receives as input the difference between NOx target value 712 and NOx measured value 72 (calculated by a subtracting device 615) and generates as output a possible reduction Δω based on the current NOx measured value 72.

In order to prevent over firing and keep NOx water system running, a minimum NOx water mass flow is needed. Block 616 is a divider which calculates a minimum ω to be ensured.

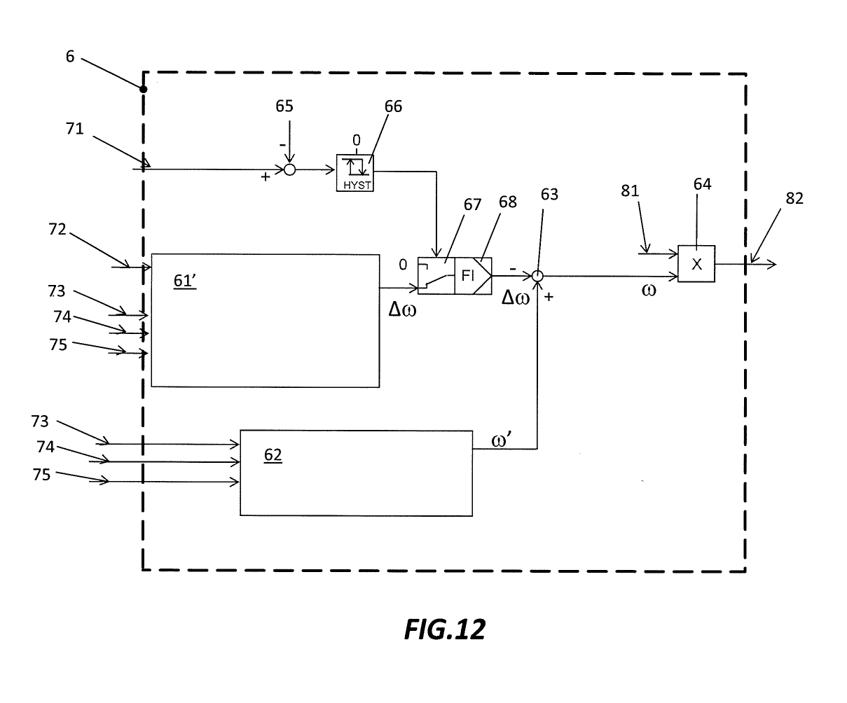

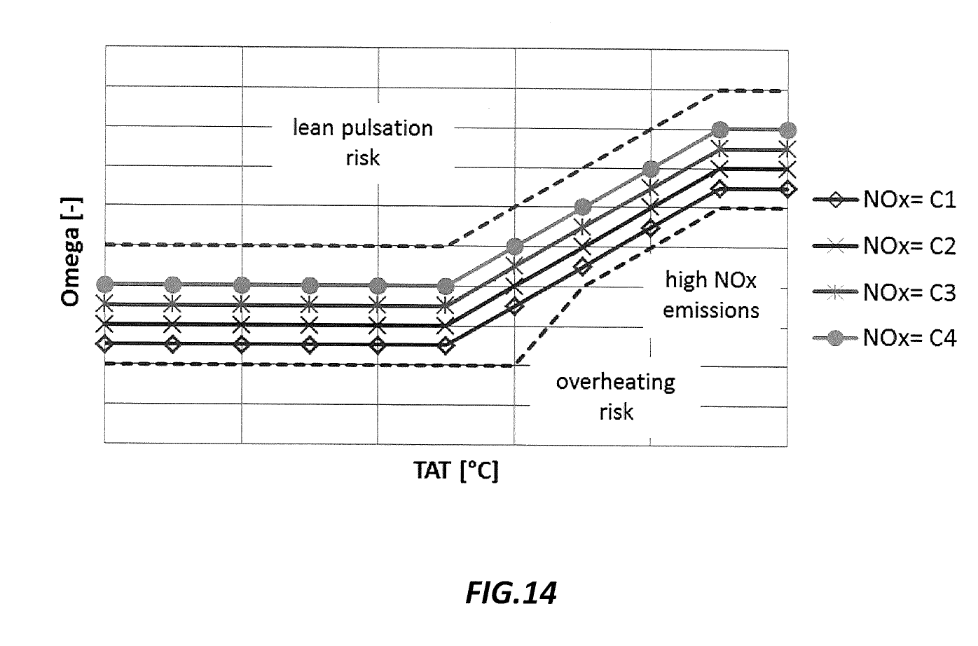

An alternative embodiment for the controller 6 is represented in next FIG. 12. It differs from the embodiment shown in FIG. 11 in the fact that a function generator block 61′ is used which generates a possible reduction Δω. Particularly, the block 61′ can reduce ω based on the measured NOx level emission. FIG. 14 shows a typical example, including various ω curves for corresponding NOx emission measured levels.

It will be appreciated that for combustion processes having several fuel stages, the system according to the invention advantageously controls parameter ω to each fuel stage, in order to minimize NOx emissions, pulsations and overall water consumption.

Moreover, for combustion processes with multiple burners or combustors/cans, a plurality of measurement systems as the one described may be utilized also to detect faulty can or combustor sectors.

For combustion processes with multiple burners or combustors/cans and multiple fuel and multiple fuel and/or NOx water control, a plurality of measurement systems as the one described may be used to adjust multiple mass flows in order to minimize emissions, pulsation, and overall water consumption.

It will be also appreciated that the system and the method according to the present invention may be applied to silo combustors, annular combustors, can combustors, sequential combustors, staged combustors, and to any combinations thereof, with separate fuel groups or stages.

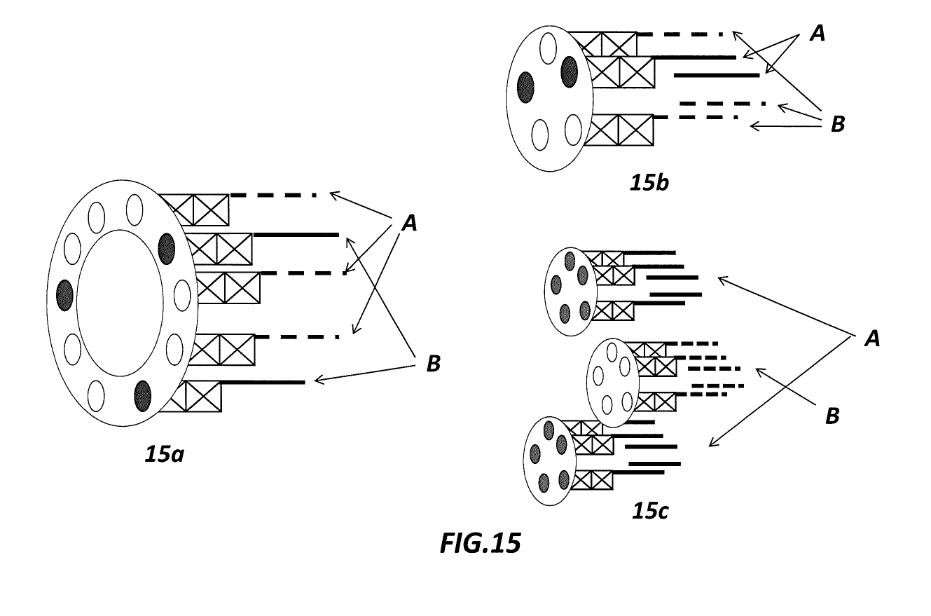

FIG. 15 shows different groupings for different kind of combustors. In particular, FIG. 15a shows a burner grouping A/B for an annular combustor; FIG. 15b shows a fuel staging grouping A/B for a can combustor; FIG. 15c shows a can grouping A/B for a can combustor.

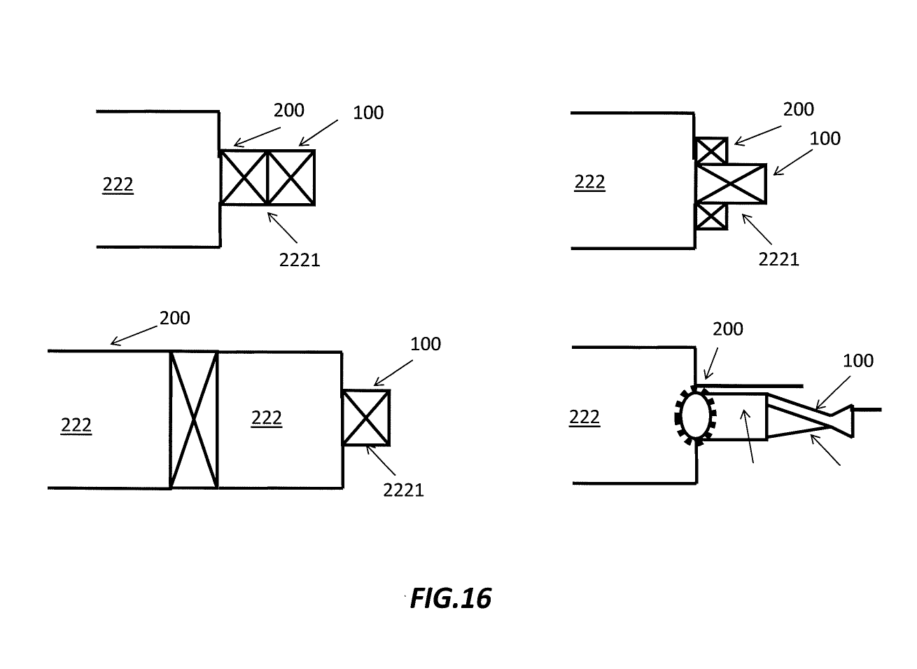

Lastly, FIG. 16 shows examples of staging options. In particular, fuel injection stages are referenced with numerals 100 and 200, associated to a burner 2221 and the combustion chamber 222 of the combustor 22.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system for controlling a combustion process of a gas turbine, the gas turbine having a combustor and a fuel feeding system configured to control a parameter co defined as a ratio between NOx water and fuel oil mass flows, said system comprising:
an apparatus for measuring NOx emission levels in exhaust of a combustor;
a measurement arrangement for measuring combustion process variables; and
a controller configured to receive input signals corresponding to measured NOx and process variables respectively from said apparatus and from said measurement arrangement;
wherein said controller is configured to elaborate a value for the parameter co based on said input signals and to generate and send an output signal correspondent to said value directed to the fuel feeding system.

2. The system according to claim 1, wherein said apparatus is capable of measuring NOx emissions within a time frame shorter than 20 sec.

3. The system according to claim 1, wherein said measuring arrangement comprises a device configured to measure pulsation levels within the combustor.

4. The system according to claim 1, wherein said apparatus for measuring NOx emission levels comprises an optical sensor device providing an array of nano and/or microcrystalline fibers.

5. The system according to claim 1, further comprising:
a fluid sample extraction assembly located in a combustor plenum, wherein said apparatus for measuring NOx emission levels is located at ambient conditions and is fluidically connected to said fluid sample extraction assembly.

6. The system according to claim 1, wherein said apparatus for measuring NOx emission levels comprises:
a sensor located inside a combustor plenum and an evaluation unit connected thereto in turn located at ambient conditions.

7. The system according to claim 3, wherein said controller comprises:
first means for calculating a parameter Δω based on measured levels of NOx emissions and pulsations.

8. The system according to claim 3, wherein said controller comprises:
second means for calculating a parameter ω′ as a predefined function of measured process variables.

9. The system according to claim 7, wherein said controller comprises:
a subtracting device configured to receive input signals corresponding to said ω′ calculated by said second means and to said Δω′ calculated by said first means, and to generate and send to the fuel feeding system an output signal corresponding to a value:
ω=ω′−Δω

10. A method for controlling a combustion process of a gas turbine, the gas turbine having at least a combustor and a fuel feeding system configured to control parameter ω defined as a ratio between NOx water mass and fuel oil flows, said method comprising:
measuring NOx emission levels in the exhaust of the combustor;
measuring combustion process variables; and
elaborating a value for said parameter ω based on said NOx emissions and measured process variables and generating an output signal correspondent to said value ω directed to the fuel feeding system.

11. The method according to claim 10, wherein each NOx emission measurement is accomplished within a time frame shorter than 20 sec.

12. The method according to claim 10, wherein said measuring combustion process variables includes measuring pulsation levels within the combustor.

13. The method according to claim 10, wherein said elaborating a value for said parameter ω comprises:
calculating a parameter ω′ as a predefined function of measured process variables.

14. The method according to claim 12, wherein said elaborating a value for said parameter ω comprises:
calculating a value Δω based on measured levels of NOx emissions and pulsations.

15. The method according to claim 13, wherein said elaborating a value for said parameter ω comprises:
subtracting said Δω from said ω′ and generating and sending to the fuel feeding system an output signal corresponding to a value: ω=ω′−Δω.
